(19) United States
(12) Patent Application Publication
(10) Pub. No.: US 2026/0268687 A1
(43) Pub. Date: Sep. 10, 2026

(54) APPARATUS AND METHOD FOR RECOGNIZING OF TARGET USING RANGE RATE

(71) Applicant: HL KLEMOVE CORPORATION, Incheon (KR)

(72) Inventor: HYUNGJUNE KIM, Incheon (KR)

(73) Assignee: HL KLEMOVE CORPORATION, Incheon (KR)

(21) Appl. No.: 19/311,295

(22) Filed: Aug. 27, 2025

(30) Foreign Application Priority Data
Mar. 6, 2025 (KR) 10-2025-0028748

(51) Int. Cl. G06V 20/58; G06V 10/26

(52) U.S. Cl. CPC G06V 20/58; G06V 10/26

(57) ABSTRACT

The present disclosure relates to an apparatus and method for recognizing a target using a range rate. The apparatus comprises a processor and a memory storing one or more programs executed by the processor. The processor performs first filtering on sensing data received from at least one radar sensor, and performs second filtering based on a histogram generated from the range rate of the first filtered sensing data to separate a tracking target into a first target and a second target based on the second filtering. Other embodiments are also applicable.

### CROSS-REFERENCE TO RELATED APPLICATION

This application claims priority to and the benefit of Korean Patent Application No. 10-2025-0028748, filed on Mar. 6, 2025, the disclosure of which is incorporated herein by reference in its entirety.

### BACKGROUND

The present disclosure relates to an apparatus and method for recognizing a target using a range rate.

Recently, with increasing demands not only for vehicle performance but also for driver convenience and safety, research and development of driver assist systems (DAS) and autonomous driving have been actively conducted. These systems assist in vehicle control based on sensing data acquired through sensors mounted on the vehicle.

In particular, autonomous driving systems mounted on vehicles generally measure the lane width, the lateral position of the vehicle relative to the lane, the distances to the lane boundaries on both sides, the lane shape, and the curvature radius of the road based on image processing of camera data. Then, based on the vehicle position and road information obtained therefrom, the systems control steering, gear shifting, acceleration, braking of the vehicle, and the like.

In addition, autonomous driving systems use a radar sensor, which is a distance sensing means mounted at a predetermined position in front of the vehicle, to detect road edges—including a preceding vehicle traveling ahead, structures installed around the road, and vehicles approaching from the opposite lane. The system calculates the distance to the preceding vehicle traveling in the same direction or to a stationary object, and provides an advanced smart cruise control function that automatically performs deceleration and acceleration according to the situation.

However, in congested traffic or road congestion situations, the range rate between the host vehicle and preceding vehicles is minimal over time, resulting in a problem in which the preceding vehicles are not clearly recognized. Therefore, to date, there is a problem in that autonomous driving or advanced smart cruise control does not function properly in road congestion situations.

### BRIEF SUMMARY

Exemplary embodiments of the present disclosure, which have been devised to solve the above-described conventional problems, are directed to providing a target recognition apparatus and method using a range rate, capable of more effectively recognizing a target, such as a preceding vehicle of a host vehicle, in congested traffic or road congestion situations by applying a range rate obtained from a radar sensor to an Otsu algorithm.

An apparatus for recognizing a target using a range rate according to an embodiment of the present disclosure for solving the above problems may include a processor; and a memory storing one or more programs executed by the processor, wherein the processor may be configured to: perform first filtering on sensing data received from at least one radar sensor; perform second filtering based on a histogram generated from a range rate derived from the first filtered sensing data; and separate a tracking target into a first target and a second target based on the second filtering.

In an embodiment of the present disclosure, the first filtering may include position gating on the sensing data.

In an embodiment of the present disclosure, the first filtering may further include range rate gating on the sensing data.

In an embodiment of the present disclosure, the histogram based on the range rate may represent a distribution of the sensing data with respect to the absolute value of an error between a reference range rate and the range rate, and the reference range rate may be calculated based on a velocity of a previously estimated target and a position of the sensing data.

In an embodiment of the present disclosure, the reference range rate is calculated according to [Mathematical Equation 1]:

$${v}_{d} = \frac{{v}_{x} x + {v}_{y} y}{r} \qquad [ Mathematical Equation 1 ]$$

(Where v_{d} denotes the reference range rate, vₓ and v_{y} represent x- and y-direction velocities of the estimated target, respectively; x and y denote horizontal and vertical distances from the radar sensor to the sensing data, respectively; and r denotes the straight-line distance from the radar sensor to the sensing data.)

In an embodiment of the present disclosure, the processor may be configured to perform the second filtering by applying the histogram to an Otsu algorithm.

In an embodiment of the present disclosure, the processor may be configured to calculate a threshold value that maximizes the variance of the absolute value of the range rate error, and distinguish the first target from the second target based on the calculated threshold value.

In an embodiment of the present disclosure, the processor may be configured to identify a target corresponding to sensing data in which the absolute value of the range rate error is distributed on a first side of the threshold value as the first target, and identify a target corresponding to sensing data in which the absolute value of the range rate error is distributed on a second side of the threshold value as the second target.

In an embodiment of the present disclosure, the processor may be configured to receive the sensing data from at least one corner radar sensor.

A method for recognizing a target using a range rate according to an embodiment of the present disclosure for solving the above problems, the method being performed by an apparatus comprising a processor and a memory storing one or more programs executed by the processor, may include receiving sensing data from at least one radar sensor; performing first filtering on the sensing data; generating a histogram based on a range rate derived from the first filtered sensing data; and performing second filtering based on the histogram to separate a tracking target into a first target and a second.

In an embodiment of the present disclosure, the performing the first filtering may include performing position gating on the sensing data.

In an embodiment of the present disclosure, the performing the first filtering may further include performing range rate gating on the sensing data.

In an embodiment of the present disclosure, the generating the histogram may include calculating a reference range rate of the sensing data; and calculating an absolute value of an error between the reference range rate and the range rate, and the reference range rate may be calculated based on a velocity of a previously estimated target and a position of the sensing data.

In an embodiment of the present disclosure, the reference range rate is calculated according to [Mathematical Equation 1]:

$${v}_{d} = \frac{{v}_{x} x + {v}_{y} y}{r} \qquad [ Mathematical Equation 1 ]$$

(Where v_{d} denotes the reference range rate, vₓ and v_{y} represent x- and y-direction velocities of the estimated target, respectively; x and y denote horizontal and vertical distances from the radar sensor to the sensing data, respectively; and r denotes the straight-line distance from the radar sensor to the sensing data.)

In an embodiment of the present disclosure, the identifying may include performing the second filtering by applying the histogram to an Otsu algorithm.

In an embodiment of the present disclosure, the performing the second filtering may include calculating a threshold value that maximizes the variance of the absolute value of the range rate error; and distinguishing the first target from the second target based on the calculated threshold value.

In an embodiment of the present disclosure, the distinguishing the first target from the second target may include identifying a target corresponding to sensing data in which the absolute value of the range rate error is distributed on a first side of the threshold value as the first target; and identifying a target corresponding to sensing data in which the absolute value of the range rate error is distributed on a second side of the threshold value as the second target.

In an embodiment of the present disclosure, the receiving the sensing data may include receiving the sensing data from a plurality of corner radar sensors.

As described above, the target recognition apparatus and method using a range rate according to the present disclosure can apply a range rate obtained from a radar sensor to an Otsu algorithm to more effectively recognize a target, such as a preceding vehicle of a host vehicle. As a result, autonomous driving or advanced smart cruise control can be safely used even in congested traffic or road congestion situations.

### BRIEF DESCRIPTION OF THE SEVERAL VIEWS OF THE DRAWINGS

FIG. 1 is a diagram illustrating the main configuration of a target recognition apparatus using a range rate according to an embodiment of the present disclosure.

FIG. 2 is a flowchart illustrating a method for recognizing a target using a range rate according to an embodiment of the present disclosure.

FIG. 3 is an example screen showing target vehicles identified by a host vehicle according to an embodiment of the present disclosure.

FIG. 4 is a diagram illustrating a method for recognizing a target using a histogram according to an embodiment of the present disclosure.

FIGS. 5A and 5B are example screens illustrating targets recognized before and after application of an Otsu algorithm according to an embodiment of the present disclosure.

### DETAILED DESCRIPTION

Hereinafter, specific embodiments according to an embodiment of the present disclosure will be described with reference to the drawings. The following detailed description is provided to aid in a comprehensive understanding of the methods, apparatuses, and/or systems described in the present specification. However, this is merely exemplary, and the present disclosure is not limited thereto.

In describing the embodiments of the present disclosure, detailed descriptions of related known technologies will be omitted when it is determined that such descriptions may unnecessarily obscure the gist of the embodiments. The terms used below are defined in consideration of the functions within the present disclosure and may vary depending on user, operator intention, or customary usage or the like. Therefore, the definitions should be interpreted based on the overall content of this specification. The terminology used in the detailed description is intended merely to describe exemplary embodiments and should not be construed as limiting. Unless explicitly stated otherwise, expressions in the singular form include the plural meaning as well. In the present description, expressions such as “comprise,” “include,” or “provide” are intended to indicate the presence of stated features, numbers, steps, operations, elements, components, or combinations thereof, and should not be interpreted as excluding the possibility of the presence or addition of one or more other features, numbers, steps, operations, elements, components, or combinations thereof. In addition, terms such as “unit,” “device,” “means,” “part,” “member,” “module,” “block.” etc., which are described in the specification, mean a unit of a comprehensive configuration that performs at least one function or operation, which may be implemented in hardware or software, or in a combination of hardware and software.

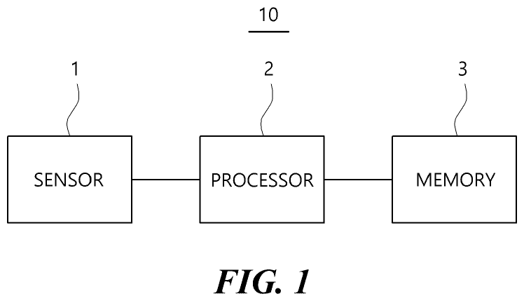

FIG. 1 is a diagram illustrating the main configuration of a target recognition apparatus using a range rate according to an embodiment of the present disclosure.

Referring to FIG. 1, an apparatus 10 according to the present disclosure may be a computing apparatus, such as an electronic apparatus, that provides an advanced smart cruise control function or an autonomous driving function of a vehicle. The apparatus 10 may include a sensor 1, a processor 2, and a memory 3.

The sensor 1 may be a radar (RADAR; radio detecting and ranging) sensor that radiates radio waves over a predetermined area and measures the time it takes for the radiated waves to be reflected and return, thereby collecting sensing data such as the position and speed of a target located in front of the vehicle. In addition, the sensor 1 in the present disclosure may refer to a plurality of corner radar sensors provided at positions such as the front-left, front-right, rear-left, and rear-right of the host vehicle. In an embodiment of the present disclosure, for convenience of explanation, a corner radar sensor provided at the front-right of the host vehicle may be described as an example.

The processor 2 collects sensing data acquired by the sensor 1, such as a radar sensor, provided at the front of the host vehicle during driving. The processor 2 generates a grid map having a plurality of grid cells of a predetermined size for a radar detection area sensed by the radar sensor.

The processor 2 performs first filtering on a plurality of targets located around the host vehicle, which are detected from the sensing data. For the first filtering, the processor 2 checks the position information of the plurality of targets and the range rate of each target with respect to the host vehicle. The range rate can be determined based on the speed difference between the host vehicle and each target.

More specifically, the processor 2 checks the position information of each of the plurality of targets identified from the sensing data with respect to the host vehicle and sets a threshold region based on the checked position information. The processor 2 performs position gating using the set threshold region to identify at least one target (or sensing data) included in the threshold region. The position gating may refer to excluding objects outside the threshold region from the analysis targets.

The processor 2 checks the range rate of at least one target included in the threshold region. The processor 2 extracts targets (or sensing data) having the same or similar range rates through range rate gating. The range rate gating may refer to excluding targets whose range rates exceed a predetermined range from the analysis targets. In this manner, the processor 2 may perform first filtering based on position gating and range rate gating.

The processor 2 generates a histogram related to the first target by checking the absolute value of the range rate error in the sensing data of the first target extracted through the first filtering. More specifically, the processor 2 calculates the absolute value of the error between the range rate of each sensing data included in the first target and a reference range rate. The distribution of the sensing data with respect to the absolute value of the error may be defined as a range-rate histogram. The reference range rate may vary for each sensing data and may be defined as shown in [Mathematical Equation 1] below.

$${v}_{d} = \frac{{v}_{x} x + {v}_{y} y}{r} \qquad [ Mathematical Equation 1 ]$$

(Where v_{d} denotes the reference range rate, vₓ and v_{y} represent the x- and y-direction velocities of the estimated target, respectively; x and y denote the horizontal and vertical distances from the radar to the sensing data, respectively; and r denotes the straight-line distance from the radar to the sensing data.)

In [Mathematical Equation 1], v may be the velocity of a tracking target estimated in a previous frame (for example, sensing data corresponding to another vehicle). That is, before clearly separating the target vehicle through the algorithm of the present disclosure, the sensing data may be presumed to correspond to the same target vehicle, and the subsequent algorithm may be applied accordingly. A frame corresponds to a divided point in time in a time series at which sensing and estimation are performed.

The processor 2 applies the generated histogram to an Otsu algorithm. The processor 2 calculates a threshold value that maximizes the variance of the absolute value of the range rate error in the histogram through the Otsu algorithm. The Otsu algorithm, which is commonly used, refers to an algorithm that automatically finds an optimal threshold value for binarization based on the brightness distribution of an input image, such as a histogram. In addition, in the embodiment of the present disclosure, the Otsu algorithm is described as being used to determine a threshold value for target segmentation by way of example, but this is for convenience of explanation and is not necessarily limited thereto.

The processor 2 performs second filtering to separate a tracking target from other targets based on the calculated threshold value. More specifically, the processor 2 may identify a target corresponding to sensing data having an absolute value of range rate error greater than or equal to 0 and less than the threshold value as a first target, and identify a target corresponding to sensing data having an absolute value of range rate error greater than or equal to the threshold value as a second target distinguished from the first target.

The processor 2 may display the separated first target and second target on the grid map.

The memory 3 may store a program for controlling the apparatus 10. In particular, the memory 3 may store an algorithm for generating a grid map for an area in which radio waves are radiated from the radar sensor, an algorithm for performing first filtering on a plurality of targets based on sensing data, and an algorithm for performing second filtering on the plurality of first targets filtered in the first filtering, and the like.

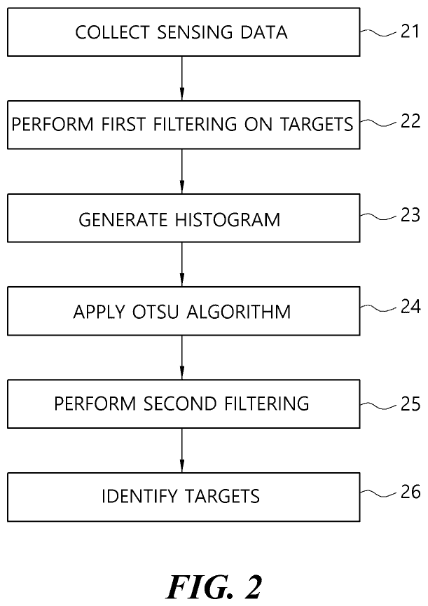

FIG. 2 is a flowchart illustrating a method for recognizing a target using a range rate according to an embodiment of the present disclosure.

Referring to FIG. 2, the processor 2 collects sensing data acquired by the sensor 1, which is a corner radar provided at a front or rear corner of the host vehicle during driving (21).

The processor 2 performs first filtering on a plurality of targets located around the host vehicle, which are detected from the collected sensing data (22). For the first filtering, the processor 2 checks the position information of the plurality of targets and the range rate of each target with respect to the host vehicle.

More specifically, the processor 2 checks the position information of each of the plurality of targets identified from the sensing data with respect to the host vehicle and sets a threshold region based on the checked position information. The processor 2 performs position gating using the set threshold region to identify at least one target included in the threshold region.

The processor 2 checks the range rate of at least one target included in the threshold region. The processor 2 extracts targets having the same or similar range rates through range rate gating. In this manner, the processor 2 may perform first filtering based on position gating and range rate gating.

The processor 2 calculates the absolute value of the range rate error of the sensing data corresponding to the first target extracted through the first filtering and generates a histogram related to the first target (23). More specifically, the processor 2 calculates the absolute value of the error between the range rate of each sensing data and a reference range rate. The distribution of the sensing data with respect to the absolute value of the error may be defined as a range-rate histogram.

The processor 2 applies the generated histogram to an Otsu algorithm (24). The processor 2 calculates a threshold value that maximizes the variance of the absolute value of the range rate error in the histogram through the Otsu algorithm.

The processor 2 performs second filtering to separate a tracking target from other targets based on the calculated threshold value. More specifically, it may identify a target corresponding to sensing data having an absolute value of range rate error greater than or equal to 0 and less than the threshold value as a first target, and identify a target corresponding to sensing data having an absolute value of range rate error greater than or equal to the threshold value as a second target distinguished from the first target.

As such, the present disclosure has the effect of resolving the problem in which multiple targets moving at similar speeds in congested traffic or road congestion situations are not separately recognized, resulting in degraded tracking performance.

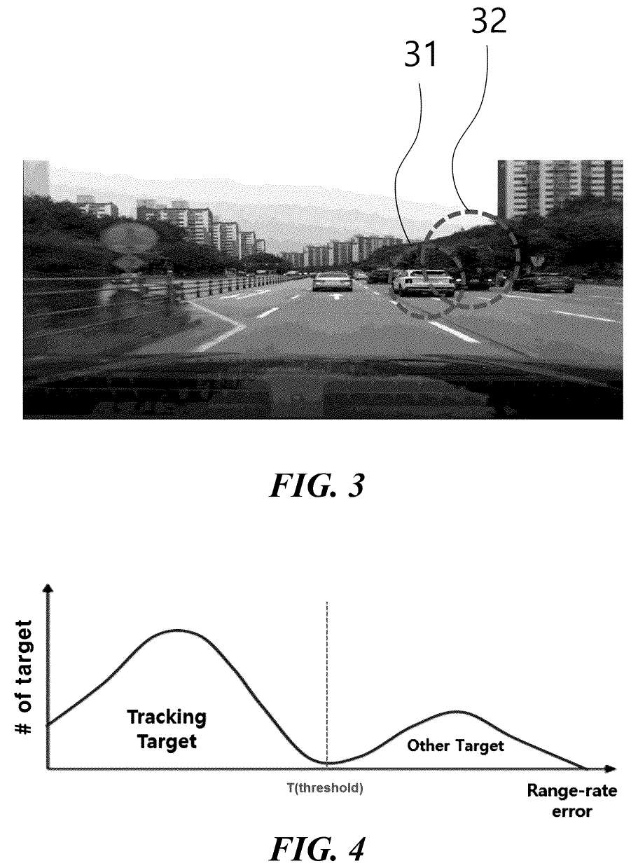

FIG. 3 is an example screen showing target vehicles identified by a host vehicle according to an embodiment of the present disclosure.

Referring to FIG. 3, FIG. 3 shows image data including a plurality of targets located ahead of the host vehicle with respect to the host vehicle during driving. In FIG. 3, reference numerals 31 and 32 denote targets located in lanes different from that of the host vehicle but positioned at the front-right of the host vehicle, and thus may be detected as a plurality of targets from the sensing data acquired by the sensor 1.

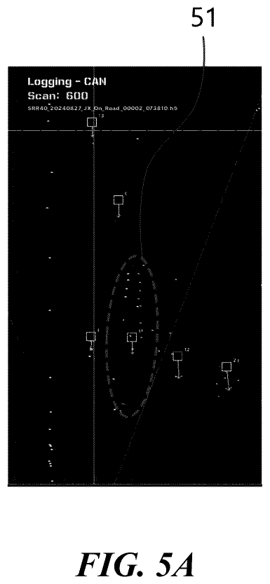

FIG. 4 is a diagram illustrating a method for recognizing a target using a histogram according to an embodiment of the present disclosure.

Referring to FIG. 4, the processor 2 generates a graph in which a histogram related to the first target is applied to an Otsu algorithm by checking the absolute value of the range rate error in the sensing data of the first target. In this manner, the processor 2 applies the histogram to the Otsu algorithm and calculates a threshold value (T) that maximizes the variance of the absolute value of the range rate error in the histogram. In FIG. 4, the x-axis represents the absolute value of the range rate error, and the y-axis represents the number of sensing data having the same absolute error value.

Based on this, the processor 2 may identify a target corresponding to sensing data having an absolute value of range rate error greater than or equal to 0 and less than the threshold value as a first target, and identify a target corresponding to sensing data having an absolute value of range rate error greater than or equal to the threshold value as a second target distinguished from the first target.

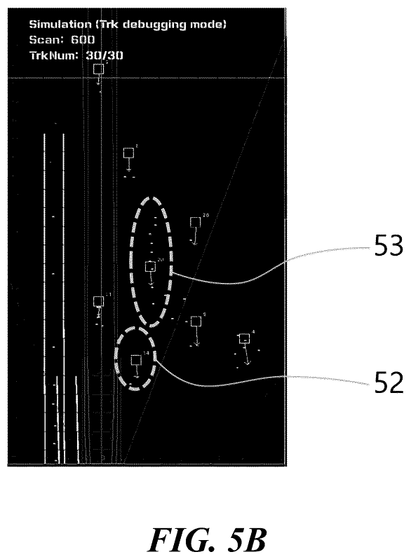

FIGS. 5A and 5B are example screens illustrating targets recognized before and after application of an Otsu algorithm according to an embodiment of the present disclosure.

FIG. 5A is a diagram showing vehicles detected as tracking targets using a method other than the Otsu algorithm based on sensing data acquired by the sensor 1 in the same environment as FIG. 3, and FIG. 5B is a diagram showing vehicles separately detected by applying the absolute values of range rate errors of the sensing data acquired by the sensor 1 to the Otsu algorithm in the same environment as FIG. 3.

For example, as shown in FIG. 3, it is desirable that the targets to be identified on the grid map based on the sensing data detected by the corner radar are two targets, such as reference numerals 31 and 32.

However, as shown in FIG. 5A, due to reasons such as estimation errors in the azimuth angle of the target, estimation errors in the length of the target, and failure to separately detect the targets, the vehicle corresponding to reference numeral 31 may be misrecognized as being the same vehicle as the one corresponding to reference numeral 32, and only vehicles such as reference numeral 51 may be displayed as targets on the grid map.

In this manner, to prevent target misrecognition based solely on sensing data, the processor 2 performs first filtering through position gating and range rate gating, generates a histogram based on the absolute value of the range rate error of the first target extracted through the first filtering, and performs second filtering by applying an Otsu algorithm to the generated histogram. When the second filtering is completed, the processor 2 may separate and identify different targets on the grid map shown in FIG. 5B, as indicated by reference numerals 52 and 53. At this time, the targets corresponding to reference numerals 52 and 53 may respectively correspond to the targets indicated by reference numerals 31 and 32 shown in FIG. 3.

The processor 2 may provide information on the identified first target and second target to the control unit of the vehicle or may directly control the vehicle based on the information on the identified first target and second target. The vehicle control may refer to control operations such as acceleration and deceleration corresponding to the separately identified targets in autonomous driving or smart cruise control.

While the present disclosure has been described in detail with reference to representative embodiments, it will be understood by those skilled in the art that various modifications and equivalent other embodiments may be possible based on the present disclosure. Accordingly, the true technical scope of the present disclosure should be defined by the spirit of the appended claims.

1. An apparatus for recognizing a target using a range rate, the apparatus comprising:
a processor; and
a memory storing one or more programs executed by the processor,
wherein the processor is configured to:
perform first filtering on sensing data received from at least one radar sensor;
perform second filtering based on a histogram generated from a range rate derived from the first filtered sensing data; and
separate a tracking target into a first target and a second target based on the second filtering.

2. The apparatus of claim 1, wherein the first filtering includes position gating on the sensing data.

3. The apparatus of claim 2, wherein the first filtering further includes range rate gating on the sensing data.

4. The apparatus of claim 3,
wherein the histogram based on the range rate represents a distribution of the sensing data with respect to the absolute value of an error between a reference range rate and the range rate, and
the reference range rate is calculated based on a velocity of a previously estimated target and a position of the sensing data.

5. The apparatus of claim 4,
wherein the reference range rate is calculated according to [Mathematical Equation 1]:
$${v}_{d} = \frac{{v}_{x} x + {v}_{y} y}{r} \qquad [ Mathematical Equation 1 ]$$
(Where v_{d} denotes the reference range rate, Vx and v_{y} represent x- and y-direction velocities of the estimated target, respectively; x and y denote horizontal and vertical distances from the radar sensor to the sensing data, respectively; and r denotes the straight-line distance from the radar sensor to the sensing data.

6. The apparatus of claim 5, wherein the processor is configured to perform the second filtering by applying the histogram to an Otsu algorithm.

7. The apparatus of claim 6,
wherein the processor is configured to:
calculate a threshold value that maximizes the variance of the absolute value of the range rate error, and
distinguish the first target from the second target based on the calculated threshold value.

8. The apparatus of claim 7,
wherein the processor is configured to:
identify a target corresponding to sensing data in which the absolute value of the range rate error is distributed on a first side of the threshold value as the first target, and
identify a target corresponding to sensing data in which the absolute value of the range rate error is distributed on a second side of the threshold value as the second target.

9. The apparatus of claim 1, wherein the processor is configured to receive the sensing data from at least one corner radar sensor.

10. A method for recognizing a target using a range rate, the method being performed by an apparatus comprising a processor and a memory storing one or more programs executed by the processor, the method comprising:
receiving sensing data from at least one radar sensor;
performing first filtering on the sensing data;
generating a histogram based on a range rate derived from the first filtered sensing data; and
performing second filtering based on the histogram to separate a tracking target into a first target and a second.

11. The method of claim 10, wherein the performing the first filtering comprises performing position gating on the sensing data.

12. The method of claim 11, wherein the performing the first filtering further comprises performing range rate gating on the sensing data.

13. The method of claim 12,
wherein the generating the histogram comprises:
calculating a reference range rate of the sensing data; and
calculating an absolute value of an error between the reference range rate and the range rate,
wherein the reference range rate is calculated based on a velocity of a previously estimated target and a position of the sensing data.

14. The method of claim 13,
wherein the reference range rate is calculated according to [Mathematical Equation 1]:
$${v}_{d} = \frac{{v}_{x} x + {v}_{y} y}{r} \qquad [ Mathematical Equation 1 ]$$
(Where v_{d} denotes the reference range rate, vₓ and v_{y} represent x- and y-direction velocities of the estimated target, respectively; x and y denote horizontal and vertical distances from the radar sensor to the sensing data, respectively; and r denotes the straight-line distance from the radar sensor to the sensing data.)

15. The method of claim 14, wherein the identifying comprises performing the second filtering by applying the histogram to an Otsu algorithm.

16. The method of claim 15,
wherein the performing the second filtering comprises:
calculating a threshold value that maximizes the variance of the absolute value of the range rate error; and
distinguishing the first target from the second target based on the calculated threshold value.

17. The method of claim 16,
wherein the distinguishing the first target from the second target comprises:
identifying a target corresponding to sensing data in which the absolute value of the range rate error is distributed on a first side of the threshold value as the first target; and
identifying a target corresponding to sensing data in which the absolute value of the range rate error is distributed on a second side of the threshold value as the second target.

18. The method of claim 11, wherein the receiving the sensing data comprises receiving the sensing data from a plurality of corner radar sensors.
